(19) United States
(12) Patent Application Publication
(10) Pub. No.: US 2016/0226893 A1
(43) Pub. Date: Aug. 4, 2016

(54) METHODS FOR OPTIMIZING AN AUTOMATED DETERMINATION IN REAL-TIME OF A RISK RATING OF CYBER-ATTACK AND DEVICES THEREOF

(71) Applicant: Wipro Limited, Bangalore (IN)

(72) Inventors: Arun Warikoo, New Delhi (IN); Bharat Shetty, Mangalore (IN); Suroop Mohan Chandran, Pune (IN)

(21) Appl. No.: 14/661,029

(22) Filed: Mar. 18, 2015

(30) Foreign Application Priority Data
Jan. 30, 2015 (IN) 470/CHE/2015

(51) Int. Cl. H04L 29/06

(52) U.S. Cl. CPC H04L 63/1416; H04L 63/1433

(57) ABSTRACT

This technology extracts threat data in real time from received incident data on each of one or more current cyber-attacks. Classified data associated with one of a plurality of prior cyber-attacks is retrieved in real time based on the extracted threat data for each of the cyber-attacks. One of a plurality of risk priorities for each of the cyber-attacks is determined in real time based on a calculated risk rating value for each of the cyber-attacks. One of a plurality of automated resolutions for each of cyber-attacks may be identified based on the retrieved classified data. The identified one of the plurality of automated resolutions for each of the cyber-attacks may automatically executed in an order based on the determined one of the plurality of risk priorities for each of the cyber-attacks.

This application claims the benefit of Indian Patent Application No. 470/CHE/2015 filed Jan. 30, 2015, which is hereby incorporated by reference in its entirety.

### FIELD

This technology generally relates to computer network security methods and devices and, more particularly, to methods that optimize an automated determination in real-time of a risk rating and a resolution for a cyber-attack and devices thereof.

### BACKGROUND

Cyber-attacks are becoming more sophisticated and possess the ability to spread in a matter of seconds. Unfortunately, prior computerized security management systems have had issues including being ill-equipped to quickly and effectively manage analysis and responses to these cyber-attacks. For example, when cyber-attacks occur with prior computerized security management systems there often are delays in mitigation of the exploitation because currently there are no effective enhanced automated categorization mechanisms or qualitative risk analysis available for prioritizing the cyber-attacks.

As a result, with these prior computerized security management systems there is a good possibility that high risk cyber-attacks are incorrectly identified and are not handled with sufficiently high priority. Additionally, with prior computerized security management systems there is no availability of analyzing and obtaining an end to end picture of how cyber-attacks occurred leading to incomplete or incorrect resolutions.

### SUMMARY

A method for optimizing an automated determination in real-time of a risk rating of a cyber-attack includes extracting, by a processor of a cyber-attack management computing device, in real time threat data from received incident data on each of one or more current cyber-attacks is received from one or more security issue identification systems. Classified data associated with one of a plurality of prior cyber-attacks is retrieved, by the cyber-attack management computing device, in real time based on the extracted threat data for each of the one or more current cyber-attacks from one or more security incident databases. One of a plurality of risk priorities for each of the one or more current cyber-attacks is determined and provided, by the processor of the cyber-attack management computing device, in real time based on a calculated risk rating value for each of the one or more current cyber-attacks.

A cyber-attack management computing device includes a memory coupled to the processor which is configured to be capable of executing programmed instructions comprising and stored in the memory to extract in real time threat data from received incident data on each of one or more current cyber-attacks from one or more security issue identification systems. Classified data associated with one of a plurality of prior cyber-attacks is retrieved in real time based on the extracted threat data for each of the one or more current cyber-attacks from one or more security incident databases. One of a plurality of risk priorities for each of the one or more current cyber-attacks is determined and provided in real time based on a calculated risk rating value for each of the one or more current cyber-attacks.

A non-transitory computer readable medium having stored thereon instructions for optimizing an automated determination in real-time of a risk rating of a cyber-attack comprising executable code which when executed by a processor, causes the processor to perform steps includes extracting in real time threat data from received incident data on each of one or more current cyber-attacks from one or more security issue identification systems. Classified data associated with one of a plurality of prior cyber-attacks is retrieved in real time based on the extracted threat data for each of the one or more current cyber-attacks from one or more security incident databases. One of a plurality of risk priorities for each of the one or more current cyber-attacks is determined and provided in real time based on a calculated risk rating value for each of the one or more current cyber-attacks.

This technology provides a number of advantages including providing methods, non-transitory computer readable media and devices that optimize an automated determination in real-time of a risk rating of a cyber-attack. With this technology, a more effective qualitative risk analysis of cyber-attacks can be performed in real time than was previously possible with and thus improving the functioning of prior computerized security management systems. Examples of this technology can analyze cyber-attack data and extract pre-defined information based on code analysis to develop a profile of an attack. Additionally, this technology can generate and provide data about and a graphical user interface visualization of an attack happening end-to-end which is not currently possible with prior computerized security management systems. Further, this technology may optionally identify and provide an automated resolution for a cyber-attack in a more efficient and fault tolerant manner than was previously available with other prior computerized security management systems.

### BRIEF DESCRIPTION OF THE DRAWINGS

FIG. 1 is a block diagram of an example of an environment with an example of a cyber-attack management computing device;

FIG. 2 is a block diagram of an example of the cyber-attack management computing device;

FIG. 3 is a functional block diagram of the environment with the example of a cyber-attack management computing device;

FIG. 4 is a functional block diagram of an example of the security incident database for the example of the cyber-attack management computing device;

FIG. 5 is a flow chart of an example of a method for optimizing an automated determination in real-time of a risk rating and optionally of a resolution for a cyber-attack;

FIG. 6 is a flow chart of an example of a method for determining the risk rating;

FIG. 7 is a flow chart of an example of a method for determining risk prioritization; and

FIG. 8 is a diagram of an example of a Table 1 with a representation of a host database and an example of a Table 2 with a basic representation of the Knowledge Database.

### DETAILED DESCRIPTION

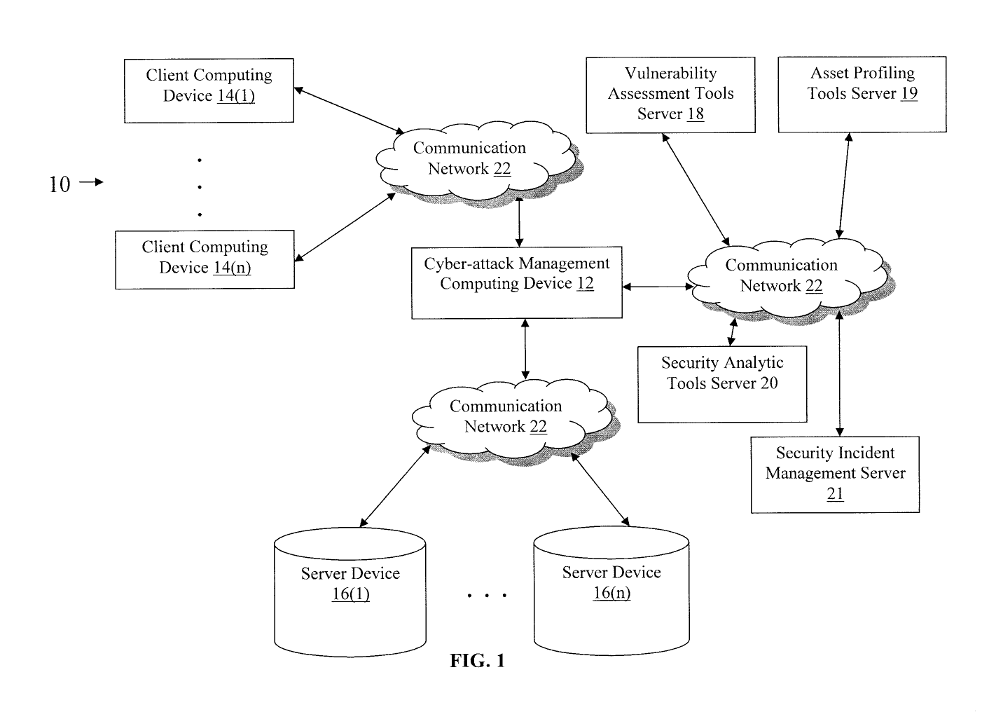

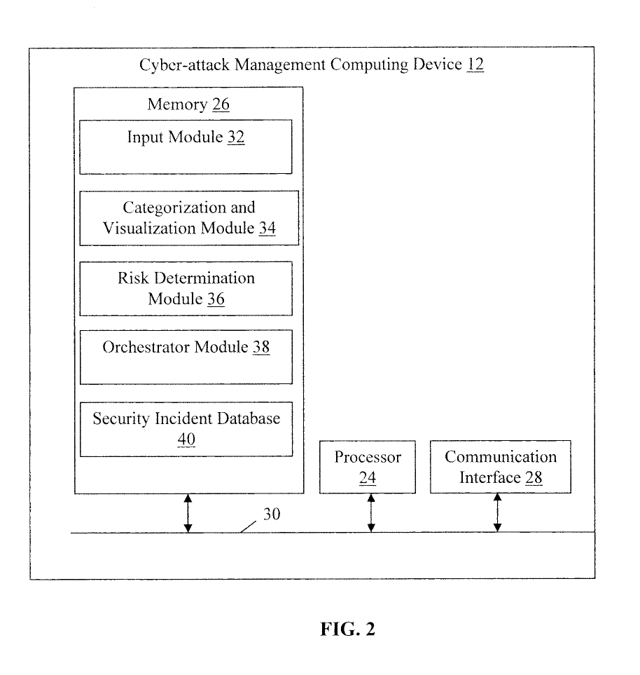

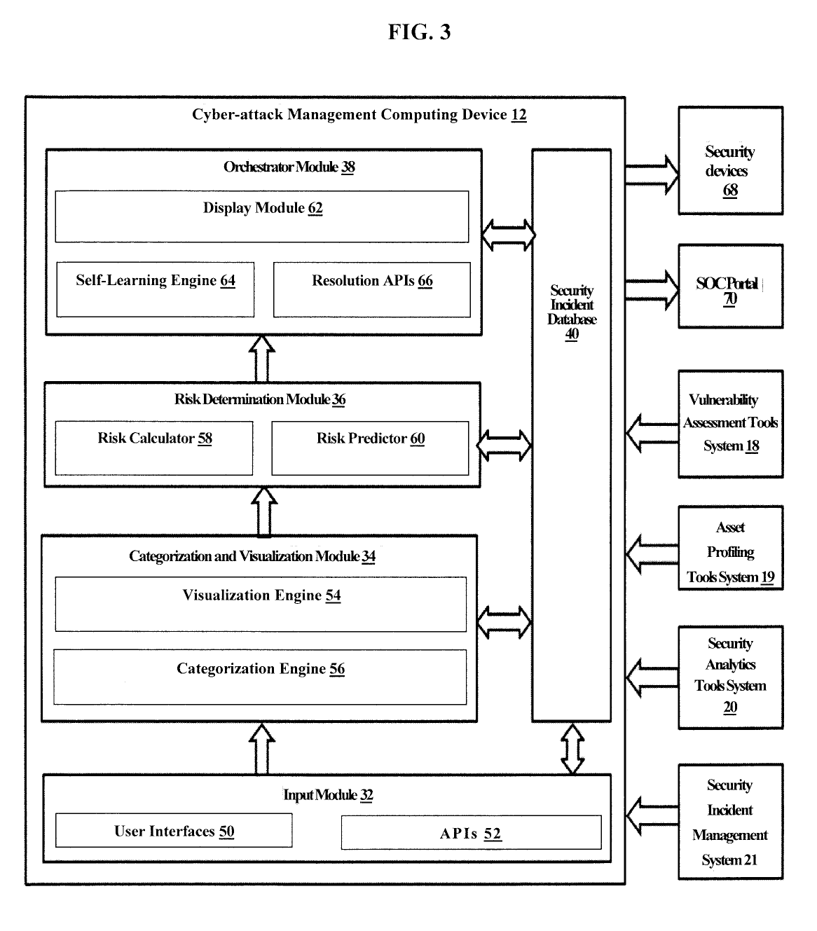

An environment 10 with exemplary cyber-attack management computing device 12 is illustrated in FIGS. 1-4. In this particular example, the environment 10 includes the cyber-attack management computing device 12, client computing devices 14(1)-14(n), server devices 16(1)-16(n), vulnerability assessment tools system 18, asset profiling tools system 19, security analytic tools system 20, and security incident management system 21 coupled via one or more communication networks 22, although the environment could include other types and numbers of systems, devices, components, and/or other elements as is generally known in the art and will not be illustrated or described herein. This technology provides a number of advantages including providing methods, non-transitory computer readable media and devices that optimize an automated determination in real-time of a risk rating and a resolution for a cyber-attack.

Referring more specifically to FIGS. 1-4, the cyber-attack management computing device 12 that can optimize an automated determination in real-time of a risk rating and a resolution for a cyber-attack, although the computing device can perform other types and/or numbers of functions or other operations and this technology can be utilized with other types of claims. In this particular example, the cyber-attack management computing device 12 includes a processor 24, a memory 26, and a communication interface 28 which are coupled together by a bus 30, although the cyber-attack management computing device 12 may include other types and/or numbers of physical and/or virtual systems, devices, components, and/or other elements in other configurations.

The processor 24 of the cyber-attack management computing device 12 may execute one or more programmed instructions stored in the memory 26 for determining in real-time a risk rating and a resolution for a cyber-attack as illustrated and described in the examples herein, although other types and numbers of functions and/or other operation can be performed. The processor 24 of the cyber-attack management computing device 12 may include one or more central processing units and/or general purpose processors with one or more processing cores, for example.

The memory 26 of the cyber-attack management computing device 12 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a, hard disk, CD ROM, DVD ROM, or other computer readable medium which is read from and written to by a magnetic, optical, or other reading and writing system that is coupled to the processor 24, can be used for the memory 26. In this particular example, the memory 26 includes an input module 32, a categorization and visualization module 34, a risk determination module 36, an orchestrator module 38, and a security incident database 40, although the memory 26 can comprise other types and/or numbers of other modules, programmed instructions and/or other data. The instructions, steps, and/or data of the input module 32, the categorization and visualization module 34, the risk determination module 36, the orchestrator module 38, and the security incident database 40 are illustrated and described by way of the examples herein.

In this particular example, the input module 32 interfaces with third party systems, such as the vulnerability assessment tools system 18, the asset profiling tools system 19, the security analytic tools system 20, and the security incident management system 21 by way of example only, and enables a security analyst to interact with, administer, and/or manage the cyber-attack management computing device 12. Additionally in this particular example, the input module 32 comprises a user interface (UI) 50 and application program interfaces (APIs) 52, although this module could include other types and/or numbers of the modules, engines, sets of programmed instructions, and/or data. The user interface 50 enables an administrator to interact with, administer, and/or manage the cyber-attack management computing device 12 and/or to add or update data to one or more of the knowledge databases 78(1) and/or 78(2) in the security incident database 40, although other types and/or numbers of interfaces could be used. The application program interfaces (APIs) 52 enable the security incident management system 21 to interface with third party systems, such as the vulnerability assessment tools system 18, asset profiling tools system 19, security analytic tools system 20, and the security incident management system 21 by way of example only, although other types and/or numbers of interfaces could be used. Each third party system is handled by one of the application program interfaces (APIs) 52. These application program interfaces (APIs) 52 extract relevant information from the third party systems. By way of example only, the one of the application program interfaces (APIs) 52 that interfaces with the security incident management system 21 extracts data real-time related to ongoing cyber-attacks.

In this particular example, the categorization and visualization module 34 generates and provides a graphical user interface of an end to end view on how a cyber-attack is happening. Additionally in this particular example, the categorization and visualization module 34 comprises a visualization engine 54 and a categorization engine 56, although this module could include other types and/or numbers of the modules, engines, sets of programmed instructions, and/or data. The visualization engine 54 enables the cyber-attack management computing device 12 to gather a classification associated with an on-going cyber-attack and build an end to end view of the cyber-attack, although this engine could be configured to be capable of executing other types and/or numbers of other functions and/or other operations.

The categorization engine 56 enables the cyber-attack management computing device 12 to analyze in real time and categorize cyber-attacks based on a cyber-attack categorization framework, although other approaches for analyzing and categorizing cyber-attacks could be used and this engine could be configured to be capable of executing other types and/or numbers of other functions and/or other operations. In this particular example, the cyber-attack categorization framework is configured to be capable of classifying cyber-attacks using a standard set of parameters per the framework, although other approaches for categorization could be used. Additionally in this particular example, the cyber-attacks are characterized based on one or more of the following parameters comprising threat actors, threat vectors, attack vectors, kill chain stages, and/or operational impact, although other types and/or numbers of parameters could be used.

In this particular example, the threat actor is defined as an entity that causes or contributes to a cyber-attack. The advantage of utilizing this parameter is that a quantified view on the risk by threat actor is provided. Additionally, in this particular example a threat vector is defined as a path or a tool that a threat actor uses to attack the target. The advantage of utilizing this parameter is that a quantified view on the risk by threat vector is provided. An attack vector may be a path by which an attacker can gain access to a host. Attack vectors enable a hacker to exploit system vulnerabilities, including the human element. The advantage of utilizing this parameter is that this identifies what vulnerabilities have been exploited, and provides a pattern on security issues within an organization.

In this particular example, a kill chain stage is based on a kill chain analysis as illustrated and discussed by way of an example below. The advantage of utilizing this parameter is that this enables risk identification.

In this particular example, operational impact refers to impact in terms of confidentiality, integrity and/or availability, although other terms may be used to quantify operational impact. The advantage of utilizing this parameter is that a quantified view on the impact to business is provided.

The categorization engine 56 enables the cyber-attack management computing device 12 to update the classification of each cyber-attack as more parameters to classify attack data are identified. In this particular example, this classification is transmitted to one or more of the knowledge databases 76(1) and/or 76(2) in the security incident database 40 and to the risk determination module 36, although the classification could be provided to other locations.

In this particular example, the risk determination module 36 determines tangible risk associated with an on-going attack in real time. Additionally, in this particular example the risk determination module 36 comprises a risk calculator module 58 and a risk predictor module 60, although this module 36 could include other types and/or numbers of the modules, engines, sets of programmed instructions, and/or data.

In this particular example, the risk calculator module 58 utilizes the input data about the cyber-attack received from the input module 32 in real-time, although this module could receive the input from other sources. The risk calculator module 58 is configured to be capable of calculating risk as a function of Asset Criticality and probability of exploitation as illustrated below, although risk can be calculated in other manners.

Risk=A×P(e)

were;

A=Asset Criticality

P(e)=Probability of Exploitation

A=a×ap

where;

â=asset value determined by the system

âp=asset profile

In this particular example, each asset is categorized into an asset type. Each asset type has a built-in asset value (a). By way of example only, a database may have a stored asset value of 10 and a user laptop may have an asset value of 1, although other types and/or numbers of assets with other values stored by the cyber-attack management computing device 12 could be used. In this particular example, the asset profile information is entered by an administrator or other operator through the user interface 50, although other manners for obtaining the asset profile information could be used. In this particular example, the asset profile information comprises a Confidentiality (C), Integrity (I) and Availability (A) score, although the asset profile information may comprise other types and/or amounts of other scores and/or data.

P(e)=function (kc)

were;
kc=Kill Chain Stage

The kill chain stage parameter on an on-going cyber-attack is extracted by the categorization and visualization module 34, although the kill chain stage parameter could be obtained in other manners. The mapping is done as follows:

If (kc=“Recon”)
then P(e)=Low

If (kc=“Exploit”)
then P(e)=Medium

If (kc=“C2C”)
then P(e)=High

If (kc=“Action”)
then P(e)=Critical

In this particular example, the risk predictor module 60 is configured to be capable of predicting the key risk indicators associated with an organization related to a cyber-attack. The risk predictor module 60 is configured to be capable of analyzing the asset profile information, a vulnerability quotient and the kill chain stage parameter associated with the cyber-attack. Next, the risk predictor module 60 is configured to be capable of analyzing historical cyber-attack data available in a global database 74 in the security incident database 40 and extracts the cyber-attacks that occurred against one or more asset profiles which are determined to be similar based on comparison data in the asset profiles. Based on the kill chain stage parameter of the existing cyber-attack, the risk predictor module 60 is able to predict the future types of cyber-attacks that could occur against the asset.

In this particular example, the orchestrator module 38 is to integrate with other systems, such as with other security devices 68 or a Security Operations Center (SOC) portal 70 by way of example only, to display the risk associated with each cyber-attack and the end to end visualization of a cyber-attack. Additionally in this particular example, the orchestrator module 38 comprises a display module 62, a self-learning engine 64, and resolution application programming interfaces (APIs) 66, although this module 38 could include other types and/or numbers of the modules, engines, sets of programmed instructions, and/or data.

In this particular example, the display module 62 enables the security management computing apparatus 12 to provide a graphical user interface representation of the cyber-attack happening real-time, the risk associated with the cyber-attack and any possible resolutions.

In this particular example, the self-learning engine 64 is configured to be capable of enabling the security management computing apparatus 12 to monitor and analyze statistical data related to cyber-attacks for self-learning. As the cyber-attacks are categorized and analyzed by the security management computing apparatus 12, the self-learning engine 64 extracts data relating to one or more vulnerabilities exploited by the ongoing cyber-attack and stores them in the global database 74 in the security incident database 40. When executable programmed instructions for a resolution to the cyber-attack become available, such as from an identification of a resolution in a stored database of resolutions or from an entry by an administrator by way of example only, the security management computing apparatus 12 loads and may execute that resolution.

In this particular example, the resolution application programming interfaces (APIs) 66 enable the cyber-attack management computing device 12 to interface with any security devices, such as a firewall. Each security type device may have its own resolution API.

In this particular example, the security incident database 40 comprises a global database 74 which is generally common for all organizations or other entities and also may contain one or more organization specific databases, although the security incident database 40 can comprise other types and/or numbers of other databases. By way of example only, an organization A database 72(1) and an organization database 72(2) are illustrated herein. In this particular example, the organization A database 72(1) comprises a knowledge database 76(1), a risk database 78(1), and a host database 80(1) that is unique to organization A, although this database could include other types and/or amounts of data. Additionally in this particular example, the organizationBdatabase 72(2) comprises a knowledge database 76(2), a risk database 78(2), and a host database 80(2) that is unique to organization B, although this database could include other types and/or amounts of data.

In this particular example, each of the knowledge databases 76(1) and 76(2) is the place where the cyber-attack classification associated with each organization is stored, although other types and/or amounts of data could be stored. Each of the knowledge databases 76(1) and 76(2) is loaded with known use-cases and is constantly updated. In an example where a use-case id corresponding to a cyber-attack is not in one of the knowledge databases 76(1) and 76(2) related to the cyber-attack, then that one of the knowledge databases 76(1) and 76(2) may be configured to be capable of proactively generates and transmitting an alert to an administrator or other entity who may update that one of the knowledge databases 76(1) and 76(2).

In this particular example, each of the risk databases 78(1) and 78(2) stores a risk rating associated with each cyber-attack, although other types and/or amounts of data could be stored. Each on-going cyber-attack is analyzed for a risk rating by the risk determination module 36, although other manners for obtaining the risk could be used and other data could be stored, such as programmed instructions for resolutions for each type of cyber-attack.

In this particular example, each of the host databases 80(1) and 80(2) stores data on an asset value and any vulnerabilities associated with each asset. Additionally, in this particular example the key risk indicators per asset also may be stored by each of the host databases 80(1) and 80(2).

In this particular example, the global database 74 stores historical information on cyber-attacks that have been previously analyzed by the security management computing apparatus 12, although other types and/or amounts of other data may be stored. Additionally, in this particular example each row in the global database 74 stores unique cyber-attack data with any associated vulnerabilities that were exploited, the impact on the organization and how the cyber-attack was resolved.

The communication interface 28 of the cyber-attack management computing device 12 operatively couples and communicates between one or more of the client computing devices 14(1)-14(n), one or more of the server devices 16(1)-16(n), the vulnerability assessment tools system 18, the asset profiling tools system 19, the security analytic tools system 20, the security incident management system 21, the security devices 68, and the SOC portal 70 which are all coupled together by one or more of the communication networks 22, although other types and/or numbers of communication networks or systems with other types and/or numbers of connections and configurations to other devices and elements. By way of example only, the communication networks 22 can use TCP/IP over Ethernet and industry-standard protocols, including NFS, CIFS, SOAP, XML, LDAP, SCSI, and SNMP, although other types and numbers of communication networks, can be used. The communication networks 22 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the client computing devices 14(1)-14(n) may run applications that may make requests for and receive responses from one or more of the server devices 16(1)-16(n) and/or may interact with other ones of the client computing devices 14(1)-14(n) within the same or different organizations or other entities and may be subjected to one or more cyber security incidents. Each of the client computing devices 14(1)-14(n) may include a processor, a memory, and a communication interface, which are coupled together by a bus or other link, although other numbers and types of devices and/or nodes as well as other network elements could be used.

The server devices 16(1)-16(n) may store and provide content or other network resources in response to requests from the client computing devices 14(1)-14(n) via one or more of the communication networks 22, for example, although other types and numbers of storage media in other configurations could be used. In particular, the server devices 16(1)-16(n) may each comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the server devices 16(1)-16(n) and transmitting data (e.g., files or web pages) in response to requests from the client computing devices 14(1)-14(n). Each of the server devices 16(1)-16(n) may include a processor, a memory, and a communication interface, which are coupled together by a bus or other link, although other numbers and types of devices and/or nodes as well as other network elements could be used.

In this particular example, the vulnerability assessment tools system 18 may be a third party system that feeds the categorization and visualization module 34 in the security management computing apparatus 12 with vulnerabilities information. Additionally, the asset profiling tools system 19 may be another third party system that feeds the categorization and visualization module 34 in the security management computing apparatus 12 with asset profiling information. The security analytic tools system 20 may be another third party system that feeds the categorization and visualization module 34 in the security management computing apparatus 12 with data associated with one or more cyber-attacks. Further, the security incident management system 21 may be another third party system that feeds the categorization and visualization module 34 in the security management computing apparatus 12 with ongoing cyber-attacks. The one or more security devices 68 may be third party systems that interface to assist with the automatic resolution of any cyber-attack. The Security Operations Center (SOC) portal 70 may be another third party system that may receive the data, such as a graphical user interface of a cyber-attack visualization and a risk associated with ongoing cyber-attack by way of example only. Each of the vulnerability assessment tools system 18, the asset profiling tools system 19, the security analytic tools system 20, the security incident management system 21, the security devices 68 and the SOC portal 70, each may include a processor, a memory, and a communication interface, which are coupled together by a bus or other link, although other numbers and types of devices and/or nodes as well as other network elements could be used.

Although the exemplary network environment 10 with the cyber-attack management computing device 12, the client computing devices 14(1)-14(n), the server devices 16(1)-16(n), the vulnerability assessment tools system 18, the asset profiling tools system 19, the security analytic tools system 20, the security incident management system 21, the security devices 68, and the SOC portal 70 and the communication networks 22 are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

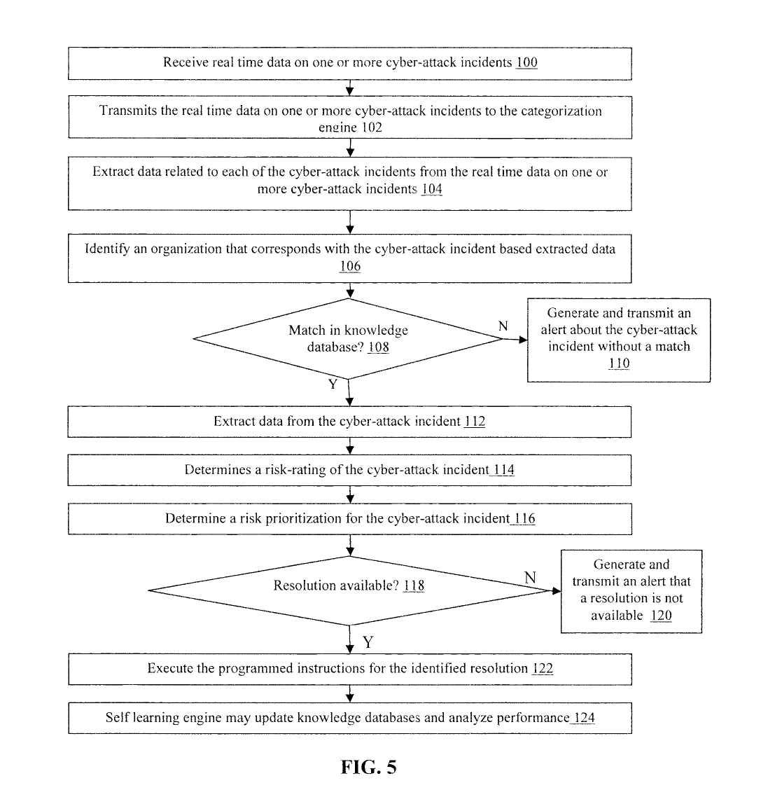

An example of a method for determining in real-time a risk rating and a resolution for a cyber-attack will now be described with reference to FIGS. 1-7. Referring more specifically to FIG. 5, in this example in step 100, the input module 32 in the cyber-attack management computing device 12 using one or more of the application programming interfaces (APIs) 52 may receive real time data on one or more cyber-attacks from the security incident management systems 21 and/or the security analytics tools system 20, although the real time data on one or more cyber-attacks could be obtained in other manners, such as from other security issue identification systems by way of example only.

In step 102, the input module 32 in the cyber-attack management computing device 12 transmits the real time data on one or more cyber-attacks to the categorization engine 56 in the categorization and visualization module 34 in the cyber-attack management computing device 12, although the data on one or more cyber-attacks can be obtained and provided in other manners.

In step 104, the categorization engine 56 in the cyber-attack management computing device 12 processes this real time data on one or more cyber-attacks in real-time to extract data related to each of the cyber-attacks, such as a Use-Case ID or a threat signature by way of example only, although other types and/or amount of data related to each of the cyber-attacks could be extracted.

In step 106, the categorization engine 56 in the cyber-attack management computing device 12 may identify an organization that corresponds with the cyber-attack based on the extracted data, such as organization A in this example.

In step 108, the categorization engine 56 in the cyber-attack management computing device 12 may executes a look up in the knowledge database 76(1) based on the extracted data, such as the Use-Case ID by way of example, and determine if there is a match. If in step 108 the categorization engine 56 in the cyber-attack management computing device 12 determines there is not a match, then the No branch is taken to step 110. In step 110 the cyber-attack management computing device 12 generates and transmits an alert about the cyber-attack without a match, such as with the display module 62 in the orchestrator module 38 by way of example only. An administrator may enter data corresponding to the non-matching cyber-attack into the knowledge database 76(1) in this example using the user interface 50 in the input module 32 and then this example of the process may end.

If in step 110 the categorization engine 56 in the cyber-attack management computing device 12 determines there is a match, then the Yes branch is taken to step 112. In step 112 the categorization engine 56 in the cyber-attack management computing device 12 extracts data from the cyber-attack, such as a threat actor, attack vector, kill chain stage, and/or threat vector by way of example only, although other types of data could be extracted. Next, the categorization engine 56 in the cyber-attack management computing device 12 transmits this extracted data to the visualization engine 54 to analyze and generate a graphical user interface illustrating the cyber-attack from end-to-end, although other types of displays illustrating the cyber-attack could be generated and to the risk determination module 36 in the cyber-attack management computing device 12 for risk determination, although the extracted data could be sent to other locations.

In step 114 the risk determination module 36 in the cyber-attack management computing device 12 determines a risk-rating of the cyber-attack. The risk determination module 36 in the cyber-attack management computing device 12 on receiving the classified data about the security incidents from the categorization engine 56 checks whether any asset information about the cyber-attack is available from the external asset profiling tools system 19, although other manners for obtaining asset information can be used. The risk determination module 36 in the cyber-attack management computing device 12 using the obtained asset profile information determines the asset criticality and a value for the probability of exploitation, ‘P(e)’. Next, the risk determination module 36 in the cyber-attack management computing device 12 calculates the risk rating is calculated using the determined asset criticality and the probability of exploitation.

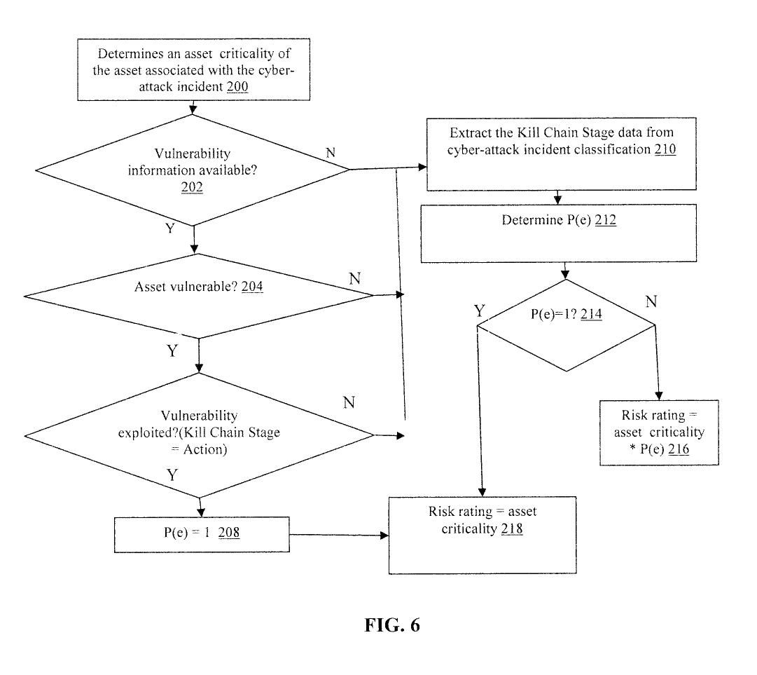

An example of a method for determining a risk rating is illustrated in FIG. 6. In step 200, the risk determination module 36 in the cyber-attack management computing device 12 determines the asset criticality of the asset associated with the cyber-attack based on the obtained asset information, although other manners for determining asset value could be used.

In step 202 the risk determination module 36 in the cyber-attack management computing device 12 determines whether any vulnerability information of the asset associated with the cyber-attack is available. If in step 202 the risk determination module 36 in the cyber-attack management computing device 12 determines vulnerability information of the asset associated with the cyber-attack is not available, then the No branch is taken to step 210 as described below. If in step 202 the risk determination module 36 in the cyber-attack management computing device 12 determines vulnerability information of the asset associated with the cyber-attack is available, then the vulnerability information is obtained and the Yes branch is taken to step 204.

In step 204 the risk determination module 36 in the cyber-attack management computing device 12 determines whether the asset associated with the cyber-attack is vulnerable based on the obtained vulnerability information. If in step 204 the risk determination module 36 in the cyber-attack management computing device 12 determines the asset associated with the cyber-attack is not vulnerable, then the No branch is taken to step 210 as described below. If in step 204 the risk determination module 36 in the cyber-attack management computing device 12 determines the asset associated with the cyber-attack is vulnerable, then the vulnerability is identified and the Yes branch is taken to step 206.

In step 206 the risk determination module 36 in the cyber-attack management computing device 12 determines whether the identified vulnerability of the asset associated with the cyber-attack is being exploited. If in step 206 the risk determination module 36 in the cyber-attack management computing device 12 determines the identified vulnerability of the asset associated with the cyber-attack is not being exploited, then the No branch is taken to step 210 as described below. If in step 206 the risk determination module 36 in the cyber-attack management computing device 12 determines the identified vulnerability of the asset associated with the cyber-attack is being exploited, then the Yes branch is taken to step 208 where the probability of exploitation P(e) is set to equal one in this example, although other values could be used.

In step 210, the risk determination module 36 in the cyber-attack management computing device 12 extracts the Kill Chain Stage data from cyber-attack incident classification.

In step 212, the risk determination module 36 in the cyber-attack management computing device 12 determines the value of the probability of exploitation P(e) based on the extracted associated vulnerability as described by way of the example earlier.

In step 214, the risk determination module 36 in the cyber-attack management computing device 12 determines whether the determined value of the probability of exploitation P(e) is equal to one. If in step 214, the risk determination module 36 in the cyber-attack management computing device 12 determines the determined value of the probability of exploitation P(e) is not equal to one, then the No branch is taken to step 216. In step 216 the risk determination module 36 in the cyber-attack management computing device 12 determines the risk rating as the obtained asset value times the determined probability of exploitation P(e), although other manners for determining or otherwise obtaining the risk rating could be used.

If in step 214, the risk determination module 36 in the cyber-attack management computing device 12 determines the determined value of the probability of exploitation P(e) is equal to one, then the Yes branch is taken to step 218. In step 218, the risk determination module 36 in the cyber-attack management computing device 12 determines the risk rating is equal to the obtained asset value), although other manners for determining or otherwise obtaining the risk rating could be used.

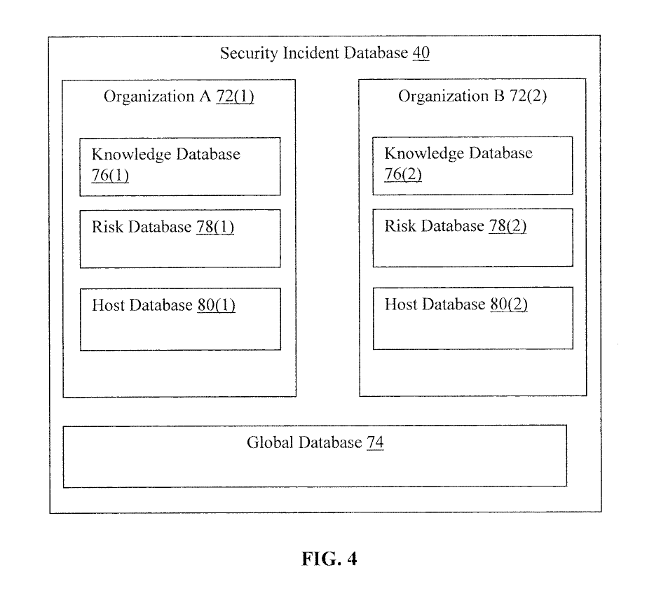

Referring back to FIG. 4, in step 116 the risk predictor module 60 in the cyber-attack management computing device 12 may determine a risk prioritization. In this particular example, the risk predictor module 60 in the cyber-attack management computing device 12 uses the determined risk rating value for determining the risk prioritization and categorizing the risk based on the determined risk prioritization. Additionally in this particular example the risk priority is determined by comparing the risk rating against four threshold values, i.e. Critical Threshold (CT), High Threshold (HT), Medium Threshold (MT) and Low Threshold (LT), although other types and/or numbers of threshold may be used.

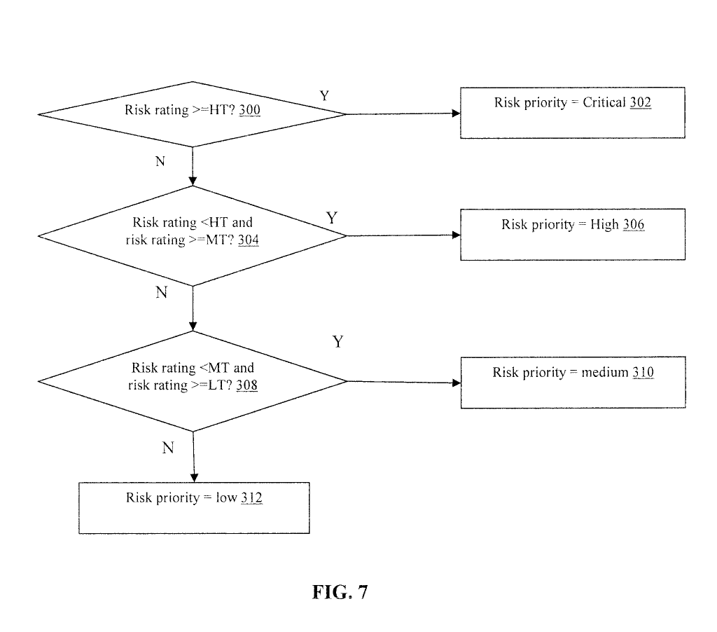

Referring to FIG. 7, an example of a method for determining risk prioritization is illustrated. In step 300, the risk determination module 36 in the cyber-attack management computing device 12 determines whether the risk rating is greater than or equal to a stored high threshold (HT) value. If in step 300 the risk determination module 36 in the cyber-attack management computing device 12 determines the risk rating is greater than or equal to a stored high threshold (HT) value, then the Yes branch is taken to step 302 where the risk priority is set to a critical value. If in step 300 the risk determination module 36 in the cyber-attack management computing device 12 determines the risk rating is not greater than or equal to a stored high threshold (HT) value, then the No branch is taken to step 304.

In step 304, the risk determination module 36 in the cyber-attack management computing device 12 determines whether the risk rating is less than the stored high threshold (HT) value and is greater than or equal to a stored medium threshold (MT) value. If in step 304 the risk determination module 36 in the cyber-attack management computing device 12 determines the risk rating is less than the stored high threshold (HT) value and is greater than or equal to a stored medium threshold (MT) value, then the Yes branch is taken to step 306 where the risk priority is set to a high value. If in step 304 the risk determination module 36 in the cyber-attack management computing device 12 determines the risk rating is less than the stored medium threshold (MT) value, then the No branch is taken to step 308.

In step 308, the risk determination module 36 in the cyber-attack management computing device 12 determines whether the risk rating is less than the stored medium threshold (MT) value and is greater than or equal to a stored lower threshold (LT) value. If in step 308 the risk determination module 36 in the cyber-attack management computing device 12 determines risk rating is less than the stored medium threshold (MT) value and is greater than or equal to a stored lower threshold (LT) value, then the Yes branch is taken to step 310 where the risk priority is set to a medium value. If in step 308 the risk determination module 36 in the cyber-attack management computing device 12 determines the risk rating is less than the stored lower threshold (LT) value, then the No branch is taken to step 312 where the risk priority is set to low value. Although in this particular example four risk priority levels are used, other types and numbers of risk priority settings could be used in other examples.

Referring back to FIG. 4, in step 118 the cyber-attack management computing device 12 may optionally determine when programmed instructions for a resolution of the cyber-attack are available in the security incident database 40, although the resolutions can be obtained in other manners and from other sources. If in step 118 the cyber-attack management computing device 12 determines a resolution of the cyber-attack is not available, then the No branch is taken to step 120. In step 120 the cyber-attack management computing device 12 may generates and transmits an alert that a resolution is not available, such as with the display module 62 in the orchestrator module 38 by way of example only.

If in step 118 the cyber-attack management computing device 12 determines an automated resolution of the cyber-attack is available, then the Yes branch is taken to step 122. In step 122, the cyber-attack management computing device 12 may execute the programmed instructions for the identified resolution.

Next, in step 124 the self-learning engine 64 in the cyber-attack management computing device 12 may monitor and update one or more of the knowledge databases 76(1) and 76(2) in this example based on the categorized cyber-attacks and rendered resolutions. The self-learning engine 64 in the cyber-attack management computing device 12 may also analyze the accuracy and efficiency of the cyber-attack management computing device 12 for determining the cyber-attacks in real-time. The self-learning engine 64 in the cyber-attack management computing device 12 may also be used for improving the risk determination capability by continuously updating the knowledge databases 76(1) and 76(2) in this example based on the self-learning analysis outcomes.

### Example

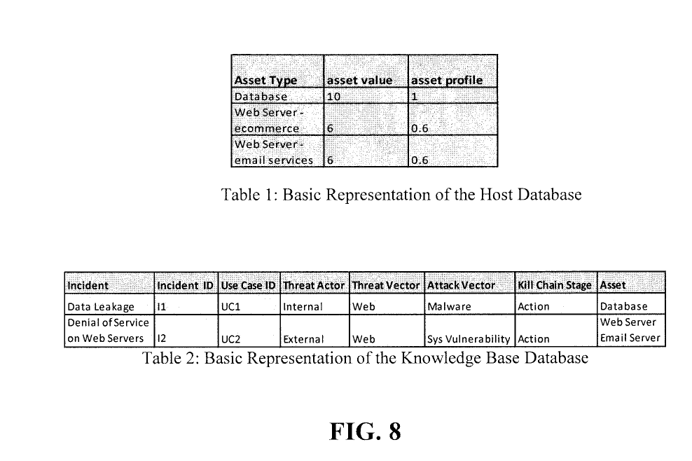

For further purposes of illustration only, a brief example of the method for optimizing an automated determination in real-time of a risk rating of a cyber-attack is set forth below. In this particular example, the cyber-attack management computing device 12 is loaded into memory 26 with the data as depicted in the exemplary Tables land 2 as shown in FIG. 8. The cyber-attack management computing device 12 is hardcoded with the asset values and default asset profile values as shown in the Table 1. Additionally, in this particular example, an ecommerce Web Server is deemed a very critical asset by the organization and as a result an administrator with the user interface 50 of the cyber-attack management computing device 12 changes the stored asset profile of the ecommerce Web Server from 0.6 to 1.

The cyber-attack management computing device 12 using one or more of the application programming interfaces (APIs) 52 may receive real time data on one or more cyber-attacks from a security incident management systems 21 or a security analytics tools system 20 comprising in this example a real time feed from a 3^{rd} party SIEM on ongoing cyber-attacks. In this particular example, the on-going cyber-attacks incident: (I1) Data Leakage—The alert is raised when an internal system communicates with and sends data to malicious URL/IP and in this example is mapped as Use Case ID-UC1 in Table 2; and (I2) Denial of Service on Web Servers—The alert is raised when there is DoS attack on web servers. Note in this particular example, each unique incident has a 1-1 mapping with a use case.

Next, in this particular example the cyber-attack management computing device 12 determines the following using the exemplary instructions illustrated and described above:

Asset Value Calculation: Asset Criticality=asset value×asset profile where: Asset Criticality=value of the host and is a function of asset value and asset profile; asset value=hardcoded value between 1-10 pre-determined by the system; and asset profile=modifiable value between 0.1-1. Accordingly, in this particular example:

Asset Criticality _{database}=10×1=10;

Asset Criticality_{Web Server-ecommerce}=6×1=6; and

Asset Criticality_{Web Server-email services}=6×0.6=3.6

Risk=Asset Criticalityₕₒₛₜ×Probability of Exploitation:

Probability of Exploitation=1; if the Kill Chain Stage associated with the incident is “Action”;

Probability of Exploitation=0.1; if the Kill Chain Stage associated with the incident is “Recon”; and

Probability of Exploitation=0.5; if the Kill Chain Stage associated with the incident is “Exploit”.

Incident-Data Leakage:

Risk_{database}=Asset Criticality_{database}×Probability of Exploitation=10×1=10;

Risk_{Web Server-ecom}=Asset Criticality_{Web Server-ecommerce}×Probability of Exploitation=6×1=6; and

Risk_{Web server-email}=Asset Criticality_{Web server-email services}×Probability of Exploitation=3.6×1=3.6

Risk Rating Calculation: High Threshold (HT)=9; Medium Threshold (MT)=6; and Low Threshold (LT)=3. Accordingly:

Risk_{database}=10 & greater that HT->risk priority is Critical;

Risk_{Web Server-ecom}=6 & between MT & HT->risk priority is High; and

Risk_{Web server-email}=3.6 & between LT & MT->risk priority is Medium.

Accordingly, as illustrated and described with the description, drawings and examples herein, this technology is able to determine in real-time a risk rating of a cyber-attack. With this technology, a qualitative risk analysis of cyber-attacks can be performed in real time in an efficient and uniform manner. This technology can analyze cyber-attack data and extract pre-defined information based on code analysis to develop a profile of an attack. Additionally, this technology can provide a graphical visualization of an attack happening end-to-end which is not currently possible. Further, this technology may optionally identify and execute a resolution for a cyber-attack in an efficient and fault tolerant manner

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for optimizing an automated determination in real-time of a risk rating of a cyber-attack, the method comprising:
extracting, by a processor of a cyber-attack management computing device, in real time threat data from received incident data on each of one or more current cyber-attacks from one or more security issue identification systems;
retrieving, by the processor of the cyber-attack management computing device, in real time classified data associated with one of a plurality of prior cyber-attacks based on the extracted threat data for each of the one or more current cyber-attacks from one or more security incident databases;
determining and providing, by the processor of the cyber-attack management computing device, in real time one of a plurality of risk priorities for each of the one or more current cyber-attacks based on a calculated risk rating value for each of the one or more current cyber-attacks.

2. The method as set forth in claim 1 further comprising:
identifying, by the processor of the cyber-attack management computing device, one of a plurality of automated resolutions for each of the one or more current cyber-attacks based on the retrieved classified data; and
automatically executing, by the processor of the cyber-attack management computing device, the identified one of the plurality of automated resolutions for each of the one or more current cyber-attacks in an order based on the determined one of the plurality of risk priorities for each of one or more current cyber-attacks.

3. The method as set forth in claim 1 further comprising outputting, by the processor of the cyber-attack management computing device, the extracted threat data for any of the one or more current cyber-attacks which does not match the classified data associated with any of the plurality of prior cyber-attacks.

4. The method as set forth in claim 1 further comprising determining, by the processor of the security management computing device, the calculated risk rating value for each of the one or more current cyber-attacks based on asset criticality and a probability of exploitation value for each asset associated with each of the one or more current cyber-attacks.

5. The method as set forth in claim 4 further comprising:
obtaining, by the processor of the cyber-attack management computing device, stored asset profile information on each asset associated with each of the one or more current cyber-attacks;
determining, by the processor of the cyber-attack management computing device, the asset criticality of each asset associated with each of the one or more current cyber-attacks based on the stored asset profile information on each asset associated with each of the one or more current cyber-attacks;
obtaining, by the processor of the cyber-attack management computing device, the probability of exploitation value of each asset associated with each of the one or more current cyber-attacks.

6. The method as set forth in claim 1 wherein the plurality of risk priorities comprises one of a high risk priority threshold, a medium risk priority threshold, or a low risk priority threshold

7. The method as set forth in claim 1 further comprising:
determining, by the processor of the cyber-attack management computing device, when one of the plurality of automated resolutions is not a match with one or more current cyber-attacks; and
outputting, by the processor of the cyber-attack management computing device, the one of the plurality of risk priorities and the retrieved classified data for each of the one or more current cyber-attacks determined not to have a match with one of the plurality of automated resolutions for generation of new resolution for the plurality of automated resolutions.

8. A cyber-attack management computing device comprising:
at least one processor; and
a memory coupled to the processor which is configured to be capable of executing programmed instructions comprising and stored in the memory to:
extract in real time threat data from received incident data on each of one or more current cyber-attacks from one or more security issue identification systems;
retrieve in real time classified data associated with one of a plurality of prior cyber-attacks based on the extracted threat data for each of the one or more current cyber-attacks from one or more security incident databases;
determine and provide in real time one of a plurality of risk priorities for each of the one or more current cyber-attacks based on a calculated risk rating value for each of the one or more current cyber-attacks.

9. The device as set forth in claim 8 wherein the processor coupled to the memory is further configured to be capable of executing at least one additional programmed instruction to:
identify one of a plurality of automated resolutions for each of the one or more current cyber-attacks based on the retrieved classified data; and
automatically execute the identified one of the plurality of automated resolutions for each of the one or more current cyber-attacks in an order based on the determined one of the plurality of risk priorities for each of one or more current cyber-attacks.

10. The device as set forth in claim 8 wherein the processor coupled to the memory is further configured to be capable of executing at least one additional programmed instruction to:
output the extracted threat data for any of the one or more current cyber-attacks which does not match the classified data associated with any of the plurality of prior cyber-attacks.

11. The device as set forth in claim 8 wherein the processor coupled to the memory is further configured to be capable of executing at least one additional programmed instruction to:
determine the calculated risk rating value for each of the one or more current cyber-attacks based on asset criticality and a probability of exploitation value for each asset associated with each of the one or more current cyber-attacks.

12. The device as set forth in claim 11 wherein the processor coupled to the memory is further configured to be capable of executing at least one additional programmed instruction to:
obtain stored asset profile information on each asset associated with each of the one or more current cyber-attacks;
determine the asset value of each asset associated with each of the one or more current cyber-attacks based on the stored asset profile information on each asset associated with each of the one or more current cyber-attacks;
obtain the probability of exploitation value of each asset associated with each of the one or more current cyber-attacks.

13. The device as set forth in claim 8 wherein the plurality of risk priorities comprises one of a high risk priority threshold, a medium risk priority threshold, or a low risk priority threshold

14. The device as set forth in claim 8 wherein the processor coupled to the memory is further configured to be capable of executing at least one additional programmed instruction to:
determine when one of the plurality of automated resolutions is not a match with one or more current cyber-attacks; and
output the one of the plurality of risk priorities and the retrieved classified data for each of the one or more current cyber-attacks determined not to have a match with one of the plurality of automated resolutions for generation of new resolution for the plurality of automated resolutions.

15. A non-transitory computer readable medium having stored thereon instructions for optimizing an automated determination in real-time of a risk rating and a resolution for a cyber-attack comprising executable code which when executed by a processor, causes the processor to perform steps comprising:
extracting in real time threat data from received incident data on each of one or more current cyber-attacks from one or more security issue identification systems;
retrieving in real time classified data associated with one of a plurality of prior cyber-attacks based on the extracted threat data for each of the one or more current cyber-attacks from one or more security incident databases;
determining and providing in real time one of a plurality of risk priorities for each of the one or more current cyber-attacks based on a calculated risk rating value for each of the one or more current cyber-attacks.

16. The medium as set forth in claim 15 further comprising:
identifying one of a plurality of automated resolutions for each of the one or more current cyber-attacks based on the retrieved classified data; and
automatically executing the identified one of the plurality of automated resolutions for each of the one or more current cyber-attacks in an order based on the determined one of the plurality of risk priorities for each of one or more current cyber-attacks.

17. The medium as set forth in claim 15 further comprising outputting the extracted threat data for any of the one or more current cyber-attacks which does not match the classified data associated with any of the plurality of prior cyber-attacks.

18. The medium as set forth in claim 15 further comprising determining the calculated risk rating value for each of the one or more current cyber-attacks based on asset criticality and a probability of exploitation value for each asset associated with each of the one or more current cyber-attacks.

19. The medium as set forth in claim 18 further comprising:
obtaining stored asset profile information on each asset associated with each of the one or more current cyber-attacks;
determining the asset value of each asset associated with each of the one or more current cyber-attacks based on the stored asset profile information on each asset associated with each of the one or more current cyber-attacks;
obtaining the probability of exploitation value of each asset associated with each of the one or more current cyber-attacks.

20. The medium as set forth in claim 15 wherein the plurality of risk priorities comprises one of a high risk priority threshold, a medium risk priority threshold, or a low risk priority threshold.

21. The medium as set forth in claim 15 further comprising:
determining when one of the plurality of automated resolutions is not a match with one or more current cyber-attacks; and
outputting the one of the plurality of risk priorities and the retrieved classified data for each of the one or more current cyber-attacks determined not to have a match with one of the plurality of automated resolutions for generation of new resolution for the plurality of automated resolutions.
